(19) United States
(12) Patent Application Publication
(10) Pub. No.: US 2021/0047745 A1
(43) Pub. Date: Feb. 18, 2021

(54) ELECTROCHEMICAL ADDITIVE MANUFACTURING OF ARTICLES

(71) Applicant: The Board of Trustees of the University of Arkansas, Little Rock, AR (US)

(72) Inventors: Robert H. CORIDAN, Fayetteville, AR (US); James M. LOWE, Fayetteville, AR (US)

(21) Appl. No.: 16/993,843

(22) Filed: Aug. 14, 2020

Related U.S. Application Data
(60) Provisional application No. 62/886,588, filed on Aug. 14, 2019.

(51) Int. Cl. C25D 1/00; B33Y 10/00

(52) U.S. Cl. CPC C25D 1/003; B33Y 10/00

(57) ABSTRACT

Methods of additive manufacturing are described herein. In one aspect, a method of printing an article comprises (a) selectively depositing an initial layer of transition metal or transition metal oxide on a substrate, and (b) at least partially replacing the initial layer of transition metal or transition metal oxide with a noble metal layer via a galvanic replacement reaction. In step (c), an additional layer of transition metal or transition metal oxide is deposited on the noble metal layer, and in step (d), the additional layer of transition metal or transition metal oxide is at least partially replaced with an additional noble metal layer via a galvanic replacement reaction. Steps (c) and (d) are repeated until the article is completed. In some embodiments, the article is subsequently separated from the substrate and can be coupled to a secondary substrate.

### RELATED APPLICATION DATA

The present application claims priority to U.S. Provisional Patent Application Ser. No. 62/886,588 filed Aug. 14, 2019 which is incorporated herein by reference in its entirety.

### STATEMENT OF GOVERNMENT RIGHTS

This invention was made with government support Grant No. 1457888 awarded by the National Science Foundation. The government has certain rights in the invention.

### FIELD

The present invention relates to the additive manufacturing of articles and, in particular, to the additive manufacturing of articles via electrochemical methods.

### BACKGROUND

Additive manufacturing generally encompasses processes in which digital 3-dimensional (3D) design data is employed to fabricate an article or component in layers by material deposition and processing. Various techniques have been developed falling under the umbrella of additive manufacturing. Additive manufacturing offers an efficient and cost-effective alternative to traditional article fabrication techniques based on molding processes. With additive manufacturing, the significant time and expense of mold and/or die construction and other tooling can be obviated. Further, additive manufacturing techniques make an efficient use of materials by permitting recycling in the process. Most importantly, additive manufacturing enables significant freedom in article design. Articles having highly complex shapes can be produced without significant expense allowing the development and evaluation of a series of article designs prior to final design selection.

However, it is often difficult to fabricate three-dimensional nanostructures and microstructures from metals and alloys. Current methods for the direct writing or printing of such structures require expensive equipment such as 3D printers based on multiphoton resists, high-powered powder sintering lasers or electron-beam lithography apparatus. Current methods also generally require high energy processes and difficult chemistries, including metal doped inks and/or organometallic compounds.

### SUMMARY

In view of the foregoing disadvantages, new and more cost efficient methods and compositions are needed for the additive manufacturing of three-dimensional nanostructures and microstructures from metals and alloys, including noble metals.

In one aspect, a method of printing an article comprises (a) selectively depositing an initial layer of transition metal or transition metal oxide on a substrate, and (b) at least partially replacing the initial layer of the transition metal or transition metal oxide with a noble metal layer via a galvanic replacement reaction. In step (c), an additional layer of transition metal or transition metal oxide is deposited on the noble metal layer, and in step (d), the additional layer of the transition metal or transition metal oxide is at least partially replaced with an additional noble metal layer via a galvanic replacement reaction. Steps (c) and (d) are repeated until the article is completed. In some embodiments, the article is subsequently separated from the substrate and can be coupled to a secondary substrate.

In another aspect, a method of printing an article comprises (a) selectively depositing an initial layer of transition metal or transition metal oxide on a substrate, and (b) at least partially replacing the initial layer with a metal layer via a galvanic replacement reaction. In step (c), an additional layer of transition metal or transition metal oxide is deposited on the metal layer, and in step (d) the additional layer is at least partially replaced with an additional metal layer via a galvanic replacement reaction. Steps (c) and (d) are repeated until the article is completed. In some embodiments, the article is subsequently separated from the substrate and can be coupled to a secondary substrate.

In a further aspect, a method of metal layer deposition comprises (a) selectively depositing a layer of transition metal or transition metal oxide on a substrate, and (b) contacting the layer of transition metal or transition metal oxide and the substrate with a metal salt solution. In step (c), a metal layer is deposited on the substrate from the metal salt solution, and (d) the transition metal or transition metal oxide layer is at least partially removed to expose areas of the substrate not coated by the metal layer.

These and other embodiments are further described in the following detailed description.

### BRIEF DESCRIPTION OF THE DRAWINGS

FIGS. 1(a) and 1(b) illustrate photoelectrochemical lithographic deposition of Cu₂O, according to some embodiments.

FIG. 1(c) illustrates galvanic replacement of Cu₂O layers by noble metal layers of silver, gold and platinum, according to some embodiments.

FIGS. 2(a) and 2(b) illustrate replacement of a Cu₂O layer by a gold layer, according to some embodiments.

FIG. 3 characterizes resolution limits of Cu₂O PECL, according to some embodiments.

FIGS. 4(a)-(e) generally illustrate steps of additive manufacturing methods described herein, according to some embodiments.

FIG. 5(a) illustrates Cu₂O grown under cathodic deposition followed by anodic dissolution of non-irradiated Cu₂O areas, according to some embodiments.

FIG. 5(b) illustrates subsequent deposition of a gold layer by exposure of the electrode and Cu₂O of FIG. 5(a) to 1 mM AuCl₄⁻ solution.

### DETAILED DESCRIPTION

Embodiments described herein can be understood more readily by reference to the following detailed description and examples and their previous and following descriptions. Elements, apparatus and methods described herein, however, are not limited to the specific embodiments presented in the detailed description and examples. It should be recognized that these embodiments are merely illustrative of the principles of the present invention. Numerous modifications and adaptations will be readily apparent to those of skill in the art without departing from the spirit and scope of the invention.

Referring now to step (a) of methods described herein, an initial layer of transition metal or transition metal oxide is selectively deposited on a substrate. Selective deposition of the transition metal or transition metal oxide can be achieved by any desired method or technique. In some embodiments, for example, the initial layer of transition metal or transition metal oxide is selectively deposited via electrodeposition. In some embodiments, for example, the electrode can be masked in the desired pattern for selective electrodeposition of transition metal or transition metal oxide. In some embodiments, the layer of transition metal or transition metal oxide is irradiated or illuminated in selective areas or sections. The initial layer of transition metal or transition metal oxide, for example, can be selectively deposited according to the methods described in PCT Patent Application Serial Number PCT/US2017/049187, which is incorporated herein by reference in its entirety. As described in this PCT application, a layer of Cu₂O is electrodeposited. The Cu₂O layer is irradiated or illuminated in selective areas or sections. Irradiation or illumination can be simultaneous with and/or subsequent to electrodeposition of the transition metal or transition metal oxide layer. Irradiation in addition to electrodeposition is termed photoelectrochemical lithography (PECL) herein.

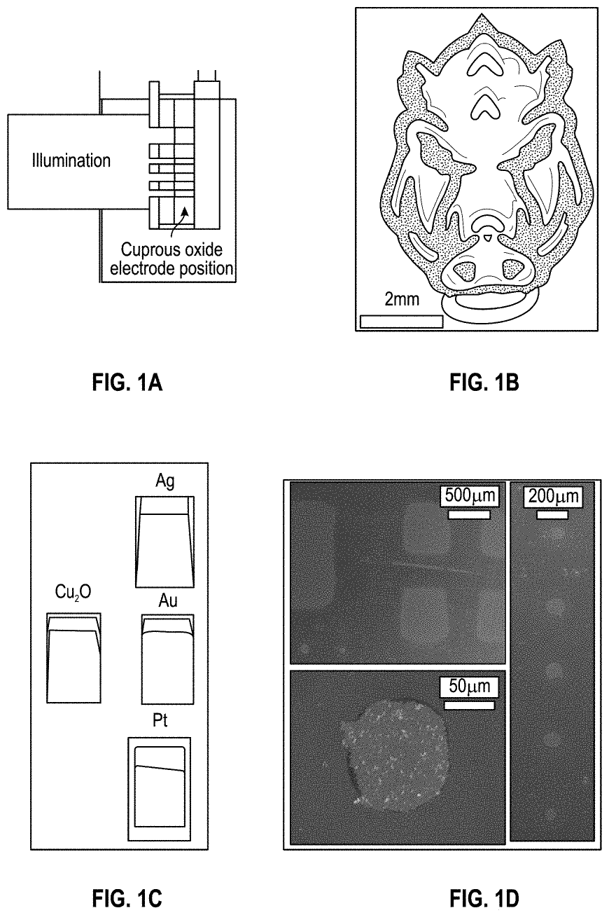

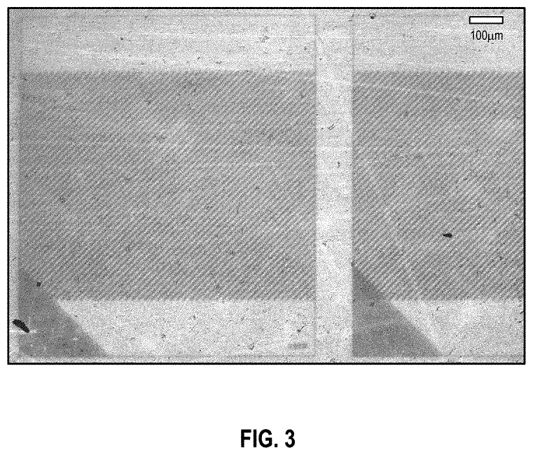

The non-irradiated or non-illuminated areas are subsequently dissolved or stripped to produce the selectively deposited transition metal or transition metal oxide layer. In the case of Cu₂O, the selectively deposited Cu₂O layer can comprise copper metal inclusions or nanoparticles, in some embodiments. FIGS. 1(a) and 1(b) illustrate photoelectrochemical lithographic deposition of Cu₂O, according to some embodiments. Photoelectrochemical lithography techniques can provide Cu₂O layers having high spatial resolution, thereby facilitating formation of nanostructures and microstructures on the article. In some embodiments, one or more masking techniques can be employed in Cu₂O deposition. Masking techniques can be employed to direct radiation to selected areas during Cu₂O deposition and/or shield radiation to selected areas. Masking techniques, for example, can be used for positive and negative imaging of Cu₂O deposition. In some embodiments, spatial resolution limits of deposited Cu₂O is 500 nm to 50 μm or 1 μm to 20 μm. FIG. 3 characterizes resolution limits of Cu₂O PECL, according to some embodiments. As illustrated in FIG. 3, line spacing of the Cu₂O film is in the 10-15 μm range. A microscope objective was used to project light patterned by a lithographic mask onto the growing Cu₂O film of FIG. 3. These masking techniques are also applicable to other layers of transition metal or transition metal oxide employed in the initial layer and additional layers described herein.

Selective deposition of the initial layer of the transition metal layer or transition metal oxide layer is not limited to electrodeposition or PECL. In some embodiments, the initial layer can be printed or stenciled on the substrate. In embodiments where electrodeposition is not employed, the substrate can comprise any non-electrically conductive substrate, if desired.

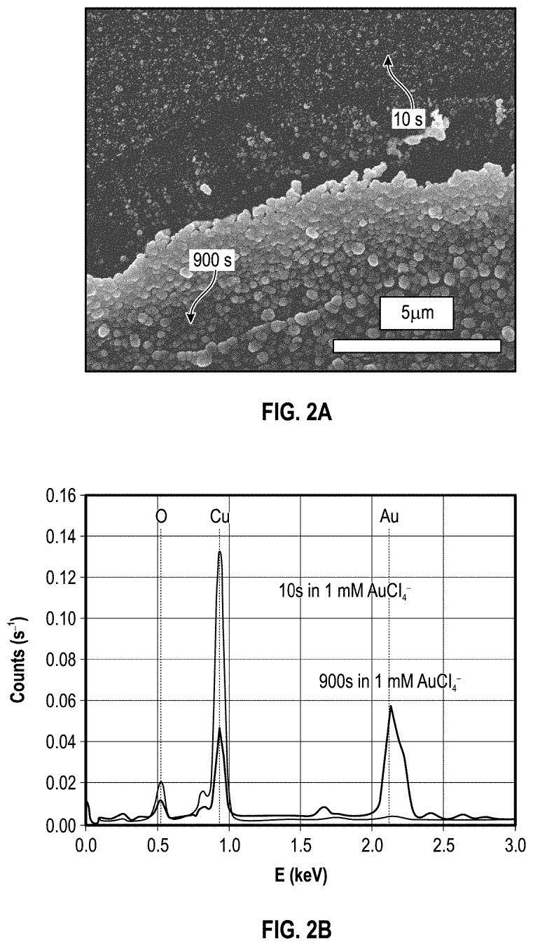

Once deposited, the initial layer of transition metal or transition metal oxide is at least partially replaced with a noble metal layer via a galvanic replacement reaction, as step (b). The transition metal layer or transition metal oxide layer, for example, can be contacted with a solution of a salt of a noble metal for the replacement reaction. In some embodiments, the entire layer of transition metal or transition metal oxide is replaced by the noble metal layer. FIG. 1(c) illustrates galvanic replacement of the Cu₂O layer by noble metal layers of silver, gold and platinum, according to some embodiments. The electrodeposited Cu₂O thin films of FIG. 1(c) were transformed into Ag, Au, or Pt via galvanic replacement by exposure to 50 mM noble metal salt in 50 mM 5-sulfosalicylic acid (pH 1.3). Moreover, FIG. 1(d) are scanning electron microscopy (SEM) images of photoelectrochemical lithography where Cu₂O was patterned with an overhead projector, then exposed to 1 mM AuCl₄⁻ (in pH 2.7 H₂SO₄). Areas illuminated during Cu₂O deposition were doped with copper metal inclusions, resulting in high-fidelity displacement via Au metal. FIG. 2(a) is a scanning electron microscopy image of the interface between an area of Cu₂O exposed to 1 mM AuCl₄⁻ solution for 10 seconds and 900 seconds. After 900 s, a continuous, thick layer of Au had deposited on the substrate. FIG. 2(b) is energy dispersive spectra (EDX) of the 10 s and 900 s regions of FIG. 2(a) showing that greater than 60% of the Cu had been displaced by Au.

In step (c), an additional layer of transition metal or transition metal oxide is deposited on the noble metal layer. The additional layer can be deposited by any technique consistent with the objectives of the present invention. In some embodiments, for example, the additional layer of transition metal or transition metal oxide is electrodeposited or deposited by photoelectrochemical lithography techniques on the noble metal layer. The additional layer of transition metal or transition metal oxide is at least partially replaced with an additional noble metal layer via a galvanic replacement reaction in step (d). Steps (c) and (d) are repeated until the article is complete.

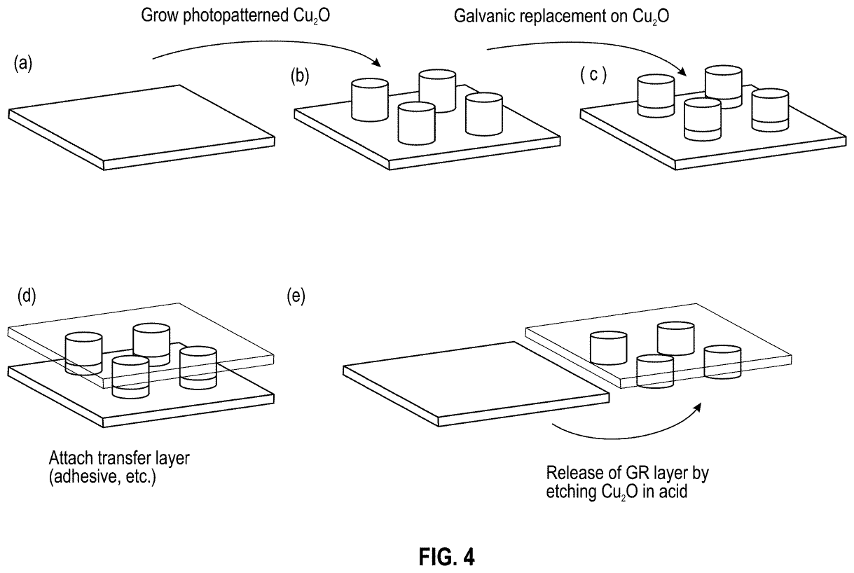

In some embodiments, steps (c) and (d) are repeated by alternating the solutions in the electrode compartment. For deposition of the additional Cu₂O layers, for example, the electrode compartment comprises solution of a suitable copper salt, such as CuSO₄. Similarly, for replacement of the Cu₂O layer with the noble metal layer, the electrode compartment comprises a salt solution of the desired noble metal. In some embodiments, the electrode serves as a build stage for the article and can be dipped into individual compartments comprising copper salt solution or noble metal salt solution, depending on the stage of the build. In further embodiments, hydrogel electrodes comprising the desired salt solution can be employed for deposition of the additional Cu₂O and noble metal layers. FIGS. 4(a)-4(d) provide a schematic of a transfer process for generalizing the PECL process. Starting from the electrode of FIG. 4(a), a patterned layer of Cu₂O is deposited, FIG. 4(b). The galvanic replacement reaction is controlled to grow a targeted noble metal layer with Cu₂O at the interface with the metal electrode, as illustrated in FIG. 4(c). The deposited noble metal layer is contacted with a transfer layer, such as an adhesive film, in FIG. 4(d) and released from the electrode in FIG. 4(e).

Layers of transition metal or transition metal oxide sacrificed in galvanic replacement reactions described herein can comprise one or more transition metals selected from Groups 8-12 of the Periodic Table, in some embodiments. For example, one or more sacrificial layers comprise nickel, copper, or oxides thereof. In some embodiments, the layers of transition metal or transition metal oxide exhibit the same compositional parameters. In other embodiments, the composition of individual sacrificial metal layers are independently chosen.

In some embodiments, the noble metal layers exhibit the same compositional parameters. In other embodiments, the composition of individual noble metal layers are independently chosen. Noble metal layers can be independently selected from Groups 8-11 of the Periodic Table. In some embodiments, for example, noble metal layers are selected from the group consisting of silver, gold, platinum, palladium, ruthenium, and iridium. Accordingly, the article may exhibit compositional gradients along the cross-section of the article. Such compositional gradients may provide desired functionality to the article. For example, in some embodiments, the article may exhibit areas or sections of selective catalytic activity. Noble metals having specific catalytic function can be selectively located in the article. In such embodiments, an article may exhibit multifunctional catalytic capabilities.

As described herein, the initial transition metal or transition metal oxide layer and additional transition metal or transition metal oxide layers are at least partially replaced by noble metal layers. In some embodiments, one or more layers of transition metal or transition metal oxide are fully replaced by noble metal layers. The degree to which a layer of transition metal or transition metal oxide is replaced can be dependent upon the time period of the galvanic replacement reaction. Thickness of a Cu₂O layer, for example, is generally inversely proportional to exposure time of the layer to a noble metal salt solution. FIGS. 2(a) and 2(b) illustrate replacement of a Cu₂O layer via a gold layer, according to some embodiments. Thickness of Cu₂O layers and noble metal layers can generally range from 50 nm to 1 μm. In some embodiments, thickness of Cu₂O layers and noble metal layers can be greater than 1 μm.

Once complete, the article can be separated from the substrate. A portion of the initial transition metal or transition metal oxide layer can remain and is subsequently dissolved for facile removal of the article from the electrode substrate. In some embodiments, the article is coupled to a secondary substrate. A secondary substrate can have any desired composition and/or functionality. A secondary substrate can be an electrically insulating material or polymeric material, in some embodiments. As described herein, FIGS. 4(a)-(e) generally illustrate the foregoing method steps, employing Cu₂O as sacrificial metal oxide layers.

Articles fabricated according to methods described herein can exhibit structural features on the micron and/or nanometer scale.

The foregoing embodiments disclose the use of metal salts of noble metals for the galvanic replacement reaction. However, salts of metals with standard electrode potentials that are positive of the standard electrode potential for Cu₂O and/or other transition metal and transition metal oxides can be employed in methods described herein.

In a further aspect, transition metal oxide, such as Cu₂O can be deposited in selected areas on a substrate followed by deposition of a metal layer on the substrate. The metal interacts with the deposited metal oxide and also covers areas of the substrate where metal oxide is not present. The transition metal oxide is etched or otherwise removed to provide areas of the substrate uncoated by the deposited metal layer. In some embodiments, the transition metal oxide is dissolved by deposition of the metal layer, as described by mechanisms herein. The transition metal oxide may also be etched or removed by processing subsequent to deposition of the metal layer. In some embodiments, all of the transition metal oxide, such as Cu₂O, is etched or removed to expose areas of the underlying substrate. Alternatively, only a portion of the transition metal oxide is removed to expose areas of the underlying substrate. The metal layer can comprise any metals described herein, including noble metals.

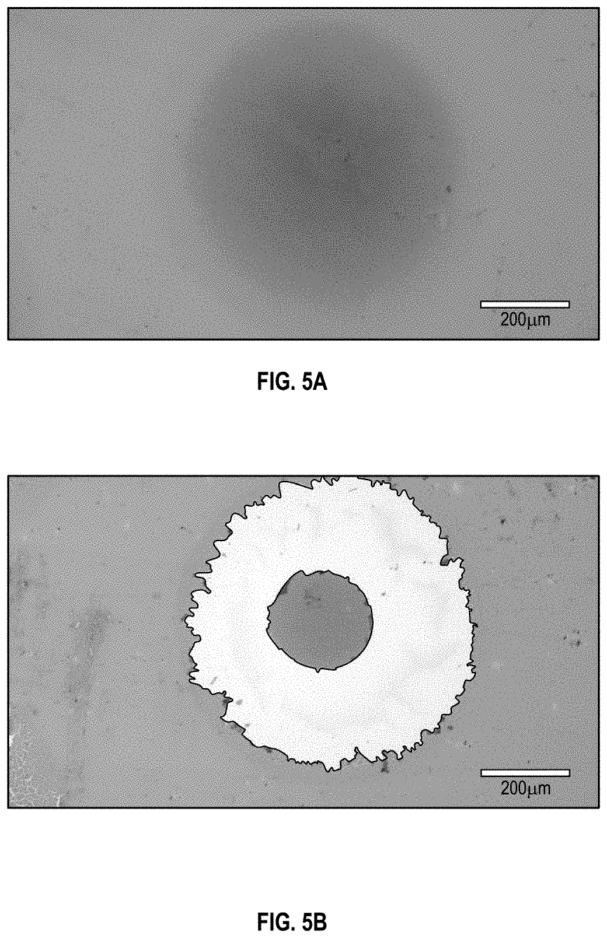

Transition metal oxide can be selectively deposited according to any desired method or technique, including the methods described herein. In some embodiments, the deposited transition metal oxide has a thickness gradient. Thinner regions of the deposited transition metal oxide, such as Cu₂O, can be removed during deposition of the metal layer. Removal of the thinner regions can expose the underlying substrate. FIG. 5(a) illustrates Cu₂O grown under cathodic deposition followed by anodic dissolution of non-irradiated Cu₂O areas. The deposited Cu₂O is thicker in the center and thinner at peripheral regions of the circle. FIG. 5(b) illustrates subsequent deposition of a gold layer by exposure of the electrode and the Cu₂O to 1 mM AuCl₄⁻ solution. Gold deposited on electrode surfaces outside the Cu₂O. Gold also deposited on the thicker central region of the Cu₂O via the galvanic replacement reaction. Thinner areas of the Cu₂O were dissolved upon exposure to the AuCl₄⁻ solution, leaving the native electrode surface (white) exposed.

Printing methods described herein, in some embodiments, can be automated. For example, dimensions and/or design of the article to be printed are provided in electronic format, such as CAD files. Suitable apparatus including container(s), print stages/substrates, pumps, and/or light sources can be employed in automated printing of articles according to methods described herein.

Various embodiments of the invention have been described in fulfillment of the various objectives of the invention. It should be recognized that these embodiments are merely illustrative of the principles of the present invention. Numerous modifications and adaptations thereof will be readily apparent to those skilled in the art without departing from the spirit and scope of the invention.

1. A method of printing an article comprising:
(a) selectively depositing an initial layer of transition metal or transition metal oxide on a substrate;
(b) at least partially replacing the initial layer of the transition metal or transition metal oxide with a noble metal layer via a galvanic replacement reaction;
(c) selectively depositing an additional layer of transition metal or transition metal oxide on the noble metal layer;
(d) at least partially replacing the additional layer of the transition metal or transition metal oxide with an additional noble metal layer via a galvanic replacement reaction; and
(e) repeating steps (c) and (d) until the article is completed.

2. The method of claim 1, wherein the initial layer of the transition metal or transition metal oxide and the additional layers of the transition metal or transition metal oxide are electrodeposited.

3. The method of claim 2, further comprising irradiating the initial layer of the transition metal or transition metal oxide and/or the additional layers of the transition metal or transition metal oxide in selected areas.

4. The method of claim 3, further comprising dissolving non-irradiated areas of the initial layer and non-irradiated areas of the additional layers of the transition metal or transition metal oxide.

5. The method of claim 1, wherein the initial layer and/or the additional layers of transition metal oxide comprise Cu₂O.

6. The method of claim 1, wherein the initial layer and the additional layers of the transition metal or transition metal oxide are contacted with noble metal salt solution.

7. The method of claim 1, wherein noble metal of the noble metal layer and the additional noble metal layers are selected from Groups 8-11 of the Periodic Table.

8. The method of claim 1, wherein compositional identity varies between the additional noble metal layers.

9. The method of claim 1, wherein the article has structural features on the micron and/or nanometer scale.

10. The method of claim 1, wherein the noble metal layer and the additional noble metal layers have thickness of at least 50 nm.

11. The method of claim 1 further comprising separating the article from the substrate.

12. The method of claim 11 further comprising coupling the article to a secondary substrate.

13. The method of claim 12, wherein the secondary substrate comprises an electrically insulating material or polymeric material.

14. The method of claim 1, wherein the three dimensional article comprises one or more layers of transition metal or transition metal oxide between adjacent noble metal layers.

15. The method of claim 1, wherein the initial layer and the additional layers of the transition metal or transition metal oxide are selectively deposited according to digital design data of the article.

16. A method of printing an article comprising:
(a) selectively depositing an initial layer of transition metal or transition metal oxide on a substrate;
(b) at least partially replacing the initial layer with a metal layer via a galvanic replacement reaction;
(c) selectively depositing an additional transition metal or transition metal oxide layer on the metal layer;
(d) at least partially replacing the additional layer with an additional metal layer via a galvanic replacement reaction; and
(e) repeating steps (c) and (d) until the article is completed.

17. The method of claim 16, wherein the initial layer and the additional layers of the transition metal or transition metal oxide are contacted with metal salt solution, the metal salt having standard electrode potential that is positive of the standard electrode potential for the layer of the transition metal or transition metal oxide.

18. The method of claim 17, wherein the initial layer and the addition layers comprise Cu₂O.

19. A method of metal layer deposition comprising;
(a) selectively depositing a layer of transition metal or transition metal oxide on a substrate;
(b) contacting the layer of the transition metal or transition metal oxide and the substrate with a metal salt solution;
(c) depositing a metal layer on the substrate from the metal salt solution; and
(d) at least partially removing the layer of the transition metal or transition metal oxide to expose areas of the substrate not coated by the metal layer.

20. The method of claim 19, wherein the transition metal oxide of the selectively deposited layer comprises Cu₂O.
